(19) United States
(12) Patent Application Publication
(10) Pub. No.: US 2018/0171874 A1
(43) Pub. Date: Jun. 21, 2018

(54) TURBINE ENGINE RAPID REACTIVATION METHOD AND SYSTEM

(71) Applicant: SAFRAN HELICOPTER ENGINES, Bordes (FR)

(72) Inventors: Thomas KLONOWSKI, Sedzere (FR); Jean-Michel BAZET, Gelos (FR); Vincent POUMAREDE, Tarbes (FR); Pierre HARRIET, Billere (FR)

(73) Assignee: SAFRAN HELICOPTER ENGINES, Bordes (FR)

(21) Appl. No.: 15/129,309

(22) PCT Filed: Mar. 19, 2015
(86) PCT No.: PCT/FR2015/050675

§ 371 Date: Sep. 26, 2016

(30) Foreign Application Priority Data
Mar. 27, 2014 (FR) 1452628

(51) Int. Cl. F02C 7/268; B64D 31/00; H02J 7/14

(52) U.S. Cl. CPC F02C 7/268; B64D 31/00; H02J 7/1423; F05D 2220/323; B64C 27/04; F05D 2260/42; F05D 2220/76; B64D 2221/00; F05D 2260/85

(57) ABSTRACT

The system for rapidly reactivating a turbine engine of an aircraft includes an electrical machine that is DC powered from an on-board electrical power supply network. The system also includes a switch interposed between the on-board network and the electrical machine, an additional set including a plurality N electrical energy storage elements, and a control unit for controlling a device for discharging the storage elements and adapted to enable a series circuit including at least some of the N electrical energy storage elements to be connected in parallel with the on-board network so that when the rapid reactivation system is in operation the electrical machine is powered by a voltage level higher than the voltage level of its nominal characteristics.

### TECHNICAL FIELD AND PRIOR ART

The invention relates to a method and a system for rapidly reactivating a turbine engine.

The field of application of the invention is more particularly that of controlling the starting of gas turbine propulsion aeroengines such as helicopter turboshaft engines or turboprops for fixed-wing aircraft.

In conventional manner, an aircraft turboshaft engine comprises a combustion chamber, a compressor shaft having a compressor wheel mounted thereon to feed said combustion chamber with compressed air, and at least one starter or generator-starter connected to said shaft in order to deliver sufficient starting torque thereto for driving it in rotation.

In order to start the turboshaft engine, the starter begins by accelerating the compressor shaft during a first starting stage in which the fuel circuit upstream from the starting injectors is put under pressure and flushed. Thereafter, in a second stage of starting, fuel injection is initiated prior to igniting said fuel in the combustion chamber of the engine. Finally, in a third stage of starting, at a predefined speed of rotation, the action of the starter is stopped and the engine can continue to accelerate as a result of the combustion of said fuel.

In order to enable the fuel to be ignited, the air delivered by the compressor wheel to the combustion chamber must satisfy certain pressure and speed conditions at the fuel injectors, so as to guarantee a precise fuel/air ratio and so as to avoid blowing out the flame. However, since the volume of air delivered by the compressor wheel to the combustion chamber is proportional to the speed of rotation of the compressor shaft, the speed of rotation of the gas generator shaft must therefore lie within a range of speeds known as the ignition window, and this must continue for a length of time that is sufficient to enable ignition to take place correctly.

Traditionally, the turboshaft engines of nearly all light or medium helicopters, and even some engines of heavy helicopters and numerous turboprops of light fixed-wing airplanes, are started using a direct current (DC) starter or a generator-starter that is powered at 28 volts (V) DC.

The invention applies more particularly to helicopters having at least two turboshaft engines. Each engine is designed so as to be oversized and capable on its own of keeping the helicopter in flight in the event of the other engine failing. Such oversized engines operate under partial load for most of the time, with the power needed for keeping the helicopter in cruising flight being relatively low. Such operation is therefore penalizing in terms of fuel consumption. That is why, in order to reduce fuel consumption under cruising conditions, it is possible to stop one of the engines. The active engine then operates at a higher power rating and thus with a more favorable level of specific consumption (Cs).

Regulator systems for optimizing specific consumption are described in particular in Documents FR 2 967 132 A1 and FR 2 967 133 A1. In those documents, on a twin-engined helicopter in low-cost cruising flight, i.e. in a stage of flight characterized by a relatively low power demand on each engine, typically of the order of 50% to 60% of its maximum continuous power (MCP), and leading to very high specific consumption, one of the two engines is put on standby (combustion chamber ignited or extinguished and with the compressor turning), such that the other engine operates at a high rating and therefore benefits from a level of specific fuel consumption that is much lower. Nevertheless, under such circumstances it is appropriate, for safety reasons, to be able to reactivate an engine in standby mode on board a twin-engined helicopter quickly in a manner that is simple and reliable.

By way of example, proposals have already been made in Document EP 2 264 297 A for a turboshaft engine fitted with a 28 V generator-starter that is coupled to the gas generator, to assist starting by means of a booster system made up of a bank of supercapacitors, which bank is connected in parallel with the 28 V battery of the helicopter. Nevertheless, that system presents drawbacks insofar as the voltage level used is constant, and not adapted to rapid reactivation, and the electrical machine constituted by the generator-starter cannot deliver the power needed for the rapid starting function throughout the entire transient stage. Furthermore, the known architecture that is proposed seeks only to start a gas generator that is stationary.

Document EP 2 581 586 A describes a system for starting helicopter engines, which uses electrical energy sources based on traditional helicopter battery technology for normal starting and which additionally uses electrical energy storage systems of the electric double layer capacitor (EDLC) supercapacitor type. The nominal voltage is that of the on-board network, i.e. 28 VDC. As a result, the starter is used in its nominal mode and the starting performance is obtained by varying the electrical characteristics of the source: during normal starting, the traditional helicopter battery is connected to the starter, while during rapid starting, the second device having the supercapacitor type storage systems is connected to the starter. As a result, under all circumstances the voltage level used remains that of the traditional helicopter batteries (e.g. 28 V), and at that voltage the electrical machine constituted by the starter cannot deliver the power needed for the rapid starting function (emergency reactivation) throughout its transient stage.

It would therefore be desirable to have a system that enables the igniting and starting turboshaft engines to be made more robust, including when they are in standby mode, however if that were done in conventional manner, it would require a DC-DC converter that is imposing, since it would need to be dimensioned for currents that are very high, possibly exceeding one thousand amps.

### Definition and Object of the Invention

The invention seeks to remedy the above-mentioned drawbacks and in particular to make it possible on a twin-engined helicopter to perform a function of emergency restarting (rapid reactivation) of one of the engines from a standby mode.

The invention seeks more particularly to provide an electrical architecture for a turboshaft engine starter system that constitutes an electrical hybridizing device satisfying in particular the following objects:
being capable of performing the conventional functions of a starter, i.e. enabling the turbine engine to be started normally and to perform dry motoring;
being capable of delivering the necessary performance for providing emergency reactivation functions, given that the electrical characteristics (voltage, impedance) of the generator elements of the on-board network of the aircraft—battery, generator or alternator—are designed to be capable of performing normal starting of the turbine engines, but are generally not sufficient for delivering the level of current needed for obtaining a burst of starting torque that is considerably higher, as is necessary of emergency reactivation;
minimizing electrical constraints and impacts on the helicopter's on-board network: generation, distribution, battery, . . . ;
being as lightweight and as well optimized as possible; and being capable, where necessary, of being incorporated easily in existing turbines and thus of being compatible with “conventional” brush generator/starters.

To solve the above-mentioned problems, there is provided an aircraft having a turbine engine with a rapid reactivation system, the system comprising an electrical machine that is DC powered from an on-board electrical power supply network included in said aircraft, and the aircraft being characterized in that it further comprises a switch interposed between the on-board electrical power supply network and the electrical machine, said switch being open to isolate the electrical machine from the on-board electrical power supply network when emergency reactivation is selected, an additional set comprising a plurality of N electrical energy storage elements, and a control unit adapted for controlling a device for discharging the electrical energy storage elements, the device for discharging the electrical energy storage elements being incorporated in the aircraft and being adapted to enable a series circuit comprising at least some of the N electrical energy storage elements to be connected in parallel with the on-board electrical power supply network, the voltage across the terminals of the electrical machine being configured by sequentially switching the number of the N storage elements so as to accompany the increase in the back-electromotive force from the electrical machine progressively as the speed of the gas generator associated with the turbine engine increases in such a manner that, while the rapid reactivation system is in operation, the electrical machine is powered by a voltage level above the level of its nominal characteristics.

Advantageously, storage elements have source impedance that is lower and power density that is higher than the source impedance and the power density of the on-board electrical power supply network, so as to be compatible with the high torque levels and thus the high current levels that are required for emergency reactivation of the turbine engine.

The storage elements may be of the electric double-layer capacitor (EDLC) supercapacitor type.

The storage elements may also be of the hybrid lithium capacitor (LIC) type.

In a particular embodiment of the invention, the control unit is associated with a device for charging and balancing and with the switch in order to control the charging of the storage elements from the electrical machine operating as an electricity generator, outside periods of rapid reactivation.

In another particular embodiment of the invention, the control unit is associated with a device for charging and balancing to control the charging of the storage elements from the on-board electrical power supply network, outside periods of rapid reactivation.

The starting system of the invention is advantageously applied to a turbine engine of a twin-engined helicopter.

The invention also provides a rapid reactivation method for rapidly reactivating an aircraft turbine engine including an electrical machine that is DC powered from an on-board electrical power supply network included in the aircraft, the method being characterized in that it comprises the steps consisting in selectively interrupting the electrical connection between said on-board electrical power supply network and said electrical machine using a switch that is in an open position in order to isolate the electrical machine from the on-board electrical power supply network when emergency reactivation is selected, and is using a control unit and a device for discharging storage elements to enable a series circuit comprising at least some of the N electrical energy storage elements to be connected in parallel with the on-board electrical power supply network, the voltage across the terminals of the electrical machine being configured by sequentially switching the number of the N storage elements so as to accompany the increase in the back-electromotive force from the electrical machine progressively as the speed of the gas generator associated with the turbine engine increases in such a manner that, while the rapid reactivation system is in operation, the electrical machine is powered by a voltage level above the level of its nominal characteristics.

The on-board electrical power supply network may include an alternator or an electricity generator, or it may be connected to a ground power unit (GPU) (when the aircraft is on the ground) or indeed it may be connected to a storage battery, e.g. a 28 V battery.

In a particular implementation, the starting method of the invention further includes a step of controlling the charging of the storage elements y a charging and balancing device from the on-board electrical power supply network, outside periods of rapid reactivation.

In another particular implementation, the starting method of the invention further comprises a step of controlling the charging of the storage elements by means of a charging and balancing device and the switch from the electrical machine operating as an electricity generator, outside periods of rapid reactivation.

The invention applies most particularly to systems for starting turboshaft engines of aircraft, and in particular of helicopters.

### BRIEF DESCRIPTION OF THE DRAWINGS

Other characteristics and advantages of the invention appear from the following description of particular embodiments given as examples and with reference to the accompanying drawings, in which:

FIG. 1 is a diagrammatic overall view of an embodiment of a device in accordance with the invention for rapidly reactivating a turbine engine;

FIGS. 2A to 2C show switch commands for discharging electrical energy storage elements in the context of a device in accordance with the invention for rapidly reactivating a turbine engine;

FIG. 3 is a diagram showing an example of how the speed or the back-emf of an electrical machine controlled in accordance with the invention varies as a function of time;

FIG. 4 is a diagram showing how the current ire an electrical machine controlled in accordance with the invention varies as a function of time;

FIG. 5 is a diagram showing how the voltage applied to an electrical machine controlled in accordance with the invention varies as a function of time;

FIG. 6 shows a first embodiment of a device for balancing and charging electrical energy storage cells that is suitable for being used in the device in accordance with the invention for rapidly reactivating a turbine engine: and

FIG. 7 shows a second embodiment of a device for balancing and charging electrical energy storage cells that is suitable for being used in the device in accordance with the invention for rapidly reactivating a turbine engine.

### DETAILED DESCRIPTION OF PREFERRED EMBODIMENTS

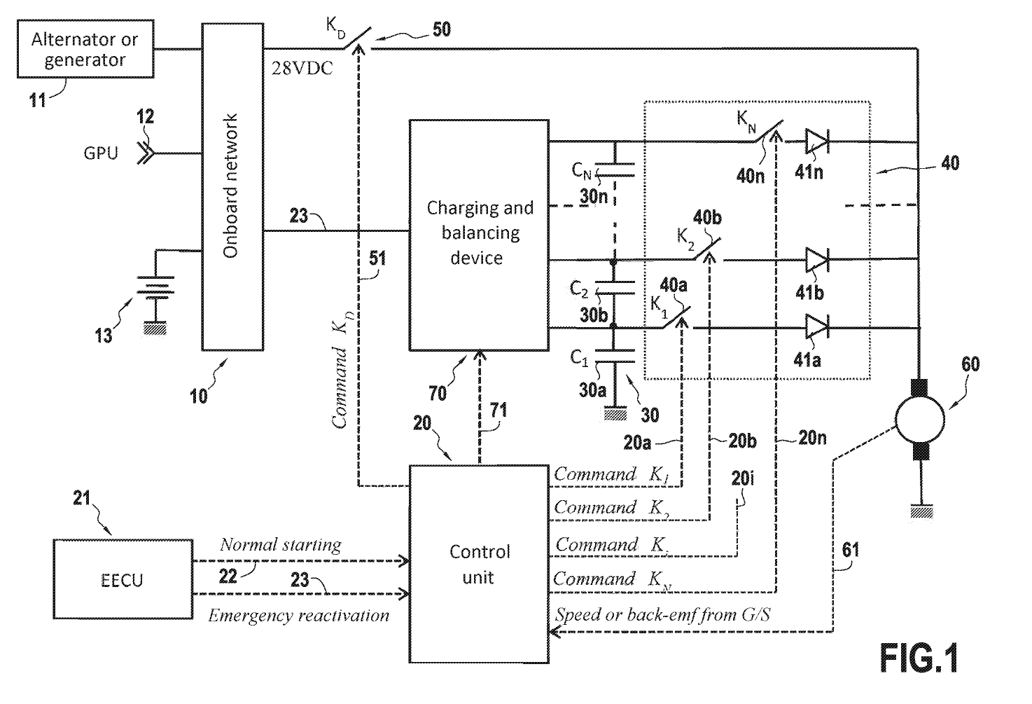

FIG. 1 is a diagram showing the general configuration of a device of the invention.

The emergency restarting system, i.e. the system for rapidly reactivating a turbine engine on standby, comprises an on-board electrical power supply network that includes, amongst other things: a storage battery 13 that may be a single battery or a group of batteries and that may be constituted by the conventional power supply of an on-board network of an aircraft, e.g. at a voltage of 28 V, however the invention is not limited to such a value.

The on-board electrical power supply network 10 may also be associated with an alternator or an electricity generator 11, or it may be connected to a ground power unit (CPU) 12 (when the aircraft is on the ground) in addition to being able to be connected to a storage battery 13, e.g. at 28 V.

An electrical machine 60 may be constituted by a simple DC starter or by a generator-starter (GS) capable of operating not only in motor mode, but also in generator mode once the stage of starting has terminated, e.g. for the purpose of powering the on-board network 10. In the description below, the term “starter” is used to cover both a device that is a starter only and a device that is a generator-starter, unless specified to the contrary.

FIG. 1 does not show the main elements of the turbine engine, which are conventional, and may comprise a gas generator, itself comprising a compressor, a combustion chamber, and a high pressure turbine, together with a free turbine and starting accessories. Likewise, FIG. 1 does not show a sensor for sensing the speed of rotation of the starter, nor a sensor for sensing the speed of rotation of the compressor shaft of the engine. Nevertheless, in diagrammatic manner, a line 61 is shown for transmitting to the control unit 20 information about the speed or the back-emf of the electrical machine 60 that may be constituted by a starter or by a generator-starter.

The starting system of the invention includes a control unit 20. FIG. 1 does not show the various sensors for measuring the operation of the engine, such as temperature sensors serving in particular to measure the operating state in the combustion chamber.

The control unit 20, which may be associated with the conventional electronic computer 21 of the engine, also known as an engine electronic control unit (EECU), or which may be directly incorporated therein, serves to manage the measurements provided by the sensors and to control the starting system via the module for managing the on-board network of an aircraft. The control unit 20 is adapted to receive a normal starting command (line 22) or an emergency reactivation command (line 3).

The starting device of the invention also includes a switch 50 (K_{D}) between the on-board network 10 and the electrical machine 60, a set 30 of N electrical energy storage elements 30a, . . . , 30n (capacitors of capacitance C₁, C₂, . . . , C_{N}), and a discharge device 40 for discharging the storage elements and for receiving commands K₁, K₂, . . . , Kᵢ, . . . , Kₙ via lines 10a, 20b, 20i, 20n from the control unit 20.

The control unit 20 controls the switch 50 via a line 51 (command K_{D}) and also controls a set of other switches 40a, 40b, . . . , 40n of the device 40 for the storage elements (commands K₁, K₂, . . . , K_{N}) enabling a series circuit comprising some or all of the N electrical energy storage elements 30a, . . . , 30n to be connected in parallel with the on-board electrical power supply network 10 in order to deliver the energy needed for emergency restarting, which constitutes rapid reactivation of the turbine previously put on standby. Diodes 41a, 41b, . . . , 41n are connected in series with the switches 40a, 40b, . . . , 40n.

Because of the additional subassemblies 20, 30, 40, 50, and 70, the system of the invention enables the voltage source that is to power the electrical machine 60 to be configured in such a manner that when the rapid reactivation system is in “emergency reactivation” operation, a voltage level is applied to the terminals of the electrical machine 60 that is higher than the level of the nominal characteristics of that electrical machine 60 in order to be able, transiently, to increase the mechanical torque it delivers, while applying the voltage gradually so as to limit the current drawn at the beginning of emergency reactivation and so as to accompany the increase in the back-emf from the starter progressively as the speed of the gas generator rises.

The storage elements 30a, . . . , 30n have source impedance that is smaller and power density that is larger than the source impedance and the power density of the storage elements of the on-board electrical power supply network 10, and they are therefore suitable for delivering high starting current during the short duration of emergency reactivation.

The additional storage elements 30a, . . . , 30n may in particular be constituted by (EDLC) supercapacitors or by hybrid lithium ion capacitors (LICs).

The operation of the starting system of the invention is described below in greater detail.

When normal starting is selected, e.g. when the aircraft is on the ground and the engine is initially stationary, the EECU 21 sends the normal starting command over the line 22 to the control unit 20, which closes the switch 50 by means of the control line 51. The starter 60 is then powered directly by the on-board network 10 and it applies a starting torque to the gas generator of the engine. In known manner, the voltage level and the impedance of the generator elements of the on-board network 10 are suitable for delivering the moderate current needed for normal starting of the engine. The same procedure is also used in flight for normal reactivation of an engine that has previously been put on standby, when restarting does not present any urgent nature.

When emergency starting is selected, while the aircraft is in flight and the engine is initially in standby mode, the EECU 21 sends the emergency reactivation command via the line 23 to the control unit 20 which performs the following functions:
opening the switch 50 so as to isolate the electrical machine 60 from the on-board network 10; and
configuring the voltage across the terminals of the electrical machine 60 by sequentially switching the number of storage elements 30a, 30n needed within the assembly 30 for the purposes firstly of managing the currents delivered to the electrical machine 60 so as to obtain mechanical torque that is considerably greater than the normal starting torque, and secondly to accompany the increase in the back-emf from the electrical machine 60 progressively as the speed of the gas generator increases.

The combinations in which the contactors 40a, 40b, . . . , 40n are closed may differ as a function of the nature of the storage elements 30a, 30b, . . . , 30n and also as a function of the characteristics of the electrical machine 60.

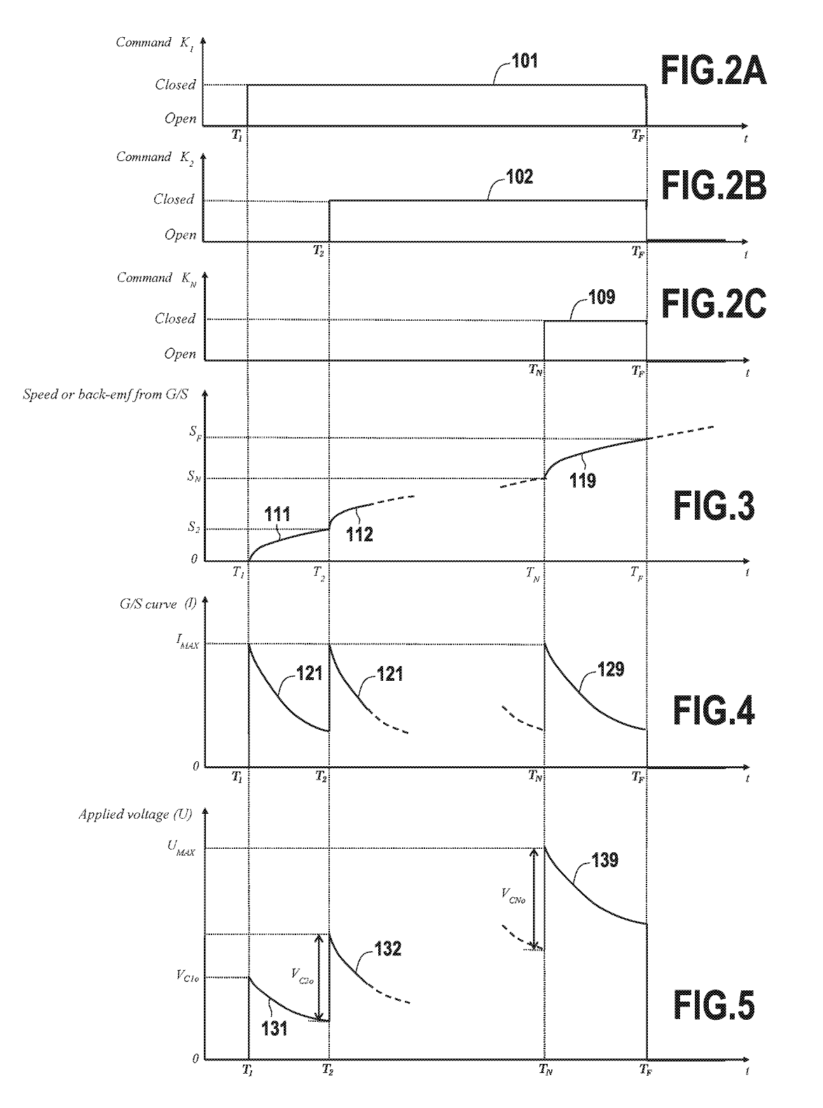

FIGS. 2A to 2C and 3 to 5 show an example of timing for controlling the switches 40a to 40n (commands K₁ to K_{N}) for limiting current and thus torque in the machine during the initial stages of emergency starting while continuing to increase its speed at the end of starting, where the electrical machine 60 is subjected to an operating voltage that is higher than its nominal operating point.

More particularly, FIG. 2A shows a signal 101 corresponding to a command K₁ that closes the contactor 40a between an initial instant T₁ and a final instant T_{F}.

FIG. 2E shows a signal 102 corresponding to a command K₂ that closes the contactor 40b between an initial instant T₂ later than the initial instant T₁, and a final instant T_{F}.

FIG. 2C shows a signal 109 corresponding to a command K_{N} that closes the last contactor 40n between an initial instant T_{N} later than any of the initial instants T₁, T₂, . . . , and a final instant T_{F}.

From FIGS. 2A, 2E, and 2C, it can understood that staggered control of the contactors 40a, 40b, 40n makes it possible to connect the storage elements 30a, 30b, . . . , 30n successively in series so as to apply the sum of the resulting voltages to the armature winding of the electrical machine 60.

FIG. 3 shows how the speed or the back-emf of the electrical machine 60 controlled in accordance with the sequence of FIGS. 2A to 2C varies as a function of time. The curve has a first segment 111 that varies between instants T₁ and T₂ between a threshold S₁ (equal to zero) and a threshold S₂, followed by successive segments 112, . . . , varying between the instants T₂ to T_{N} between thresholds S₂ to S_{N}, and finally a last segment 119 that varies between the instant T_{N} and a final instant T_{F} between the threshold S_{N} and a final threshold S_{F} presenting a maximum value.

FIG. 4 shows how the current flowing through the electrical machine 60 controlled in accordance with the sequence of FIGS. 2A to 2C varies as a function of time. At each initial instant that a command K₁, K₂, . . . , K_{N} is applied at successive instants T₁, T₂, . . . , T_{N}, the current reaches a maximum value I_{MAX} and then decreases (segments 121, 122, . . . , 129) and returns to zero at the final instant T_{F}. Suitable contactor commands K₁, K₂, . . . , K_{N} serve to limit the maximum current absorbed by the electrical machine 60, and thus its torque, to a level that is acceptable for the mechanical train driving the gas generator, while nevertheless maintaining a high mean level of torque throughout the emergency activation sequence.

FIG. 5 shows how the voltage applied to the electrical machine 60 controlled in accordance with the sequence of FIGS. 2A to 2C varies as a function of time. At each initial instant that a command K₁, K₂, . . . , K_{N} is applied at successive instants T₁, T₂, . . . , T_{N}, the voltage applied to the electrical machine 60 increases from a value V_{C10}, V_{C20}, . . . , V_{CN0} equal to the value corresponding to the initial charge of the storage elements 30a, 30b, . . . , 30n, and then decreases (segments 131, 132, . . . , 139) during discharging of the storage elements as connected in parallel in this way with the electrical machine 60, while nevertheless remaining at a value that increases progressively until it reaches a value U_{MAX} at the initial instant of the command K_{N} for closing the last contactor 40n. Appropriate contactor commands K₁, K₂, . . . , K_{N} thus enable the level of the voltage applied to the electrical machine 60 to be adapted gradually as the speed, and thus the back-emf, of the machine increases, thereby enabling a large mean starting torque to be maintained on the gas generator up to high speeds. It should be observed that although the maximum voltage level U_{MAX} that is applied to the electrical machine 60 at the end of emergency activation exceeds the nominal voltage of the on-board network, it nevertheless remains compatible with the strength of the insulation and with the commutator of the electrical machine, for exceptional use.

When operating under normal conditions, i.e. other than during a period of emergency activation, the control unit 20 and the device 70 for charging and balancing the cells also has the function of charging and keeping charged the storage elements 30a, . . . , 30n of the set 30 of additional storage elements, and in general manner of monitoring these storage elements 30a to 30n.

The storage elements 30a, . . . , 30n of the additional set 30 may be charged from the power supply network 10 of the helicopter, or in a variant from the electrical machine 60 operating as an electricity generator.

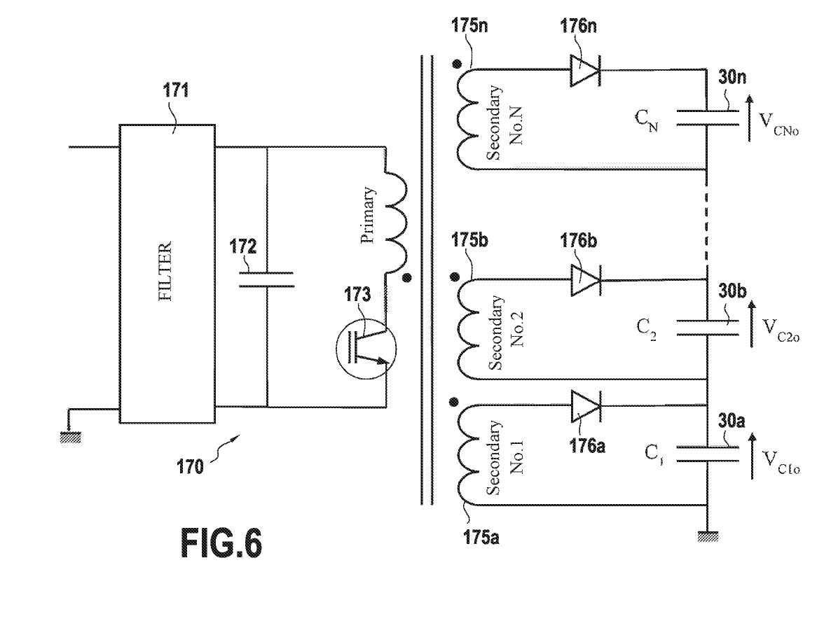

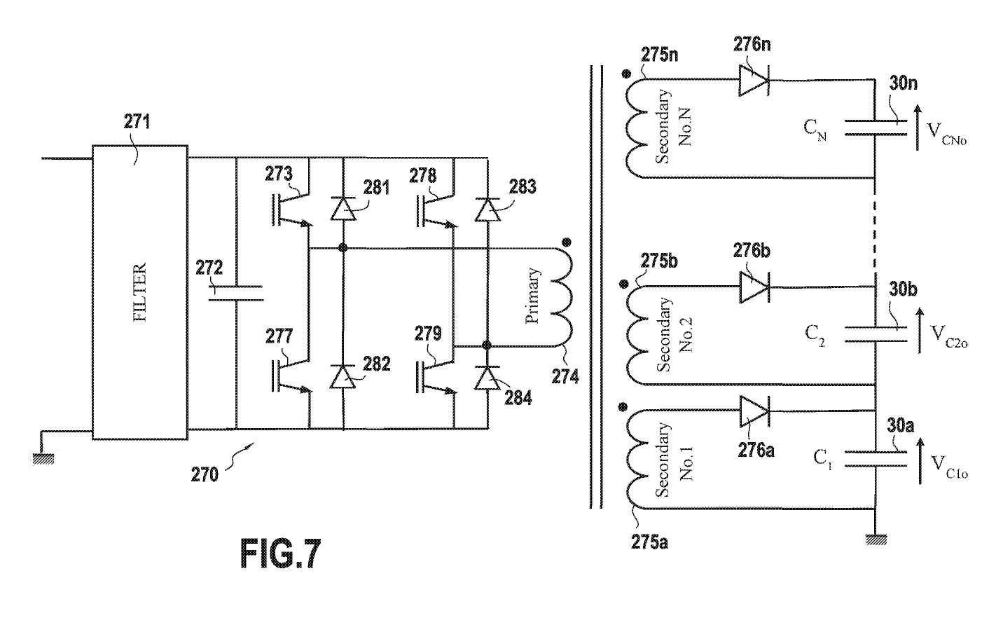

FIGS. 6 and 7 show two examples of the operation of the device 70 for balancing and charging cells constituted by the storage elements 30a, 30b, . . . , 30n. As shown in FIG. 1, the device 70 for balancing and charging the cells may be powered from the on-board network 10 by a connection 72 and may be controlled selectively by the control unit 20 (connection 71) during periods lying outside emergency reactivation. The balancing and charging devices described in FIGS. 6 and 7 are given respective references 170 and 270.

The FIG. 6 balancing and charging device is of “flyback” structure and comprises at its input a filter unit 171 followed by a capacitor 172 connected in parallel with a circuit having a primary winding 174 of a transformer and an electronic control member 173. A set of N secondary windings 175a, 175b, 175n of the transformer are connected via rectifier diodes 176a, 176b, . . . , 176n to a set of N electrical energy storage elements 30a, 30b, . . . , 30n so as to deliver voltages V_{C10}, V_{C20}, . . . , V_{CN0} to the terminals of the various electrical energy storage elements having capacitances C₁, C₂, . . . , C_{N}.

The balancing and charging device of FIG. 7 is of “forward” structure and comprises at its input a filter unit 271, followed by a capacitor 272 connected in parallel with a circuit comprising a set of electronic components for powering a primary winding 274 of a transformer. The electronic components may comprise an H bridge made up of four diodes 281 to 284 and four electronic control members 273, 277, 278, 279. A set of N secondary transformer windings 275a, 275b, . . . , 275n are connected via rectifier diodes 276a, 276b, . . . , 276n to feed a set of N electrical energy storage elements 30a, 30b, . . . , 30n in such a manner as to deliver voltages V_{C10}, V_{C20}, . . . , V_{CN0} to the terminals of the various electrical energy storage elements having capacitances C₁, C₂, . . . , C_{N}.

The embodiment of FIG. 6, in which the primary winding 174 of the transformer is considered as being a current source, enables energy to be transferred, with energy being stored in the primary winding. It is thus possible to control the energy that is transferred to the transformer secondary windings 175a, 175b, . . . , 175n. This solution optimizes the weight of the control electronics to the detriment of the weight of the inductive element.

The embodiment of FIG. 7, in which the transformer primary 274 is considered as being a voltage source, serves to optimize the size of the inductive element, to the detriment of the control electronics. The system of the invention is suitable for achieving emergency restarting in flight of a turboshaft engine in a few seconds.

It should be observed that advantageously, the storage elements 30a, 30b, . . . , 30n may be recharged on the ground, with the engines idling during a stage of preparing the aircraft prior to takeoff, so that the corresponding electrical energy which is taken off may be spread over a duration that is relatively long (a few tens of seconds to a few minutes) without any negative operational impact, which thus makes it possible firstly to avoid oversizing the generator elements of the on-board network, and secondly to reduce the power for which the recharging devices as described in FIGS. 6 and 7 are designed, thereby in particular enabling their weight and volume to be limited.

The additional equipment of the system of the invention is very simple to put into place and it is very compact. Thus, the additional set 30 of storage elements, the control unit 20, the balancing device 70, and the discharge device 40 can be incorporated directly in the engine compartment of the engine.

The invention is also suitable for being used on helicopters that are already in operation, given that the modifications that need to be made to existing circuits can be implemented simply.

The invention thus proposes using practical technical means for implementing, on board a twin-engined helicopter, a function of emergency restarting (rapid reactivation) from a standby mode. In the invention, the electric starter 60 of a turbine is thus used outside its nominal operating range in order to handle the call for mechanical power that is needed for emergency restarting in flight.

1. An aircraft comprising:
a turbine engine with a rapid reactivation system, the system comprising an electrical machine that DC powered from an on-board electrical power supply network included in said aircraft, and wherein the aircraft further comprises a switch interposed between the on-board electrical power supply network and the electrical machine, said switch being open to isolate the electrical machine from the on-board electrical power supply network when emergency reactivation is selected, an additional set comprising a plurality of N electrical energy storage elements, and a control unit adapted for controlling a device for discharging the electrical energy storage elements, the device for discharging the electrical energy storage elements, being incorporated in the aircraft and being adapted to enable a series circuit comprising at least some of the N electrical energy storage elements to be connected in parallel with the on-board electrical power supply network, the voltage across the terminals of the electrical machine being configured by sequentially switching the number of the N storage elements so as to accompany the increase in the back-electromotive force from the electrical machine progressively as the speed of the gas generator associated with the turbine engine increases in such a manner, that while the rapid reactivation system in operation, the electrical machine is powered by a voltage level above the level of its nominal characteristics.

2. The aircraft according to claim 1, wherein storage elements have source impedance that is lower and power density that is higher than the source impedance and the power density of the on-board electrical power supply network.

3. The aircraft according to claim 1, wherein the storage elements are of the electric double-layer capacitor supercapacitor type.

4. The aircraft according to claim 1, wherein the storage elements are of the hybrid lithium capacitor type.

5. The aircraft according to claim 1, wherein the control unit is associated with a device for charging and balancing and with the switch in order to control the charging of the storage elements from the electrical machine operating as an electricity generator, outside periods of rapid reactivation.

6. The aircraft according to claim 1, wherein the control unit is associated with a device for charging and balancing to control the charging of the storage elements from the on-board electrical power supply network, outside periods of rapid reactivation.

7. The aircraft according to claim 1, wherein it is constituted by a twin-engined helicopter.

8. A rapid reactivation method for rapidly reactivating an aircraft turbine engine including an electrical machine that is DC powered from an on-board electrical power supply network included in said aircraft, the method comprising:
selectively interrupting the electrical connection between said on-board electrical power supply network and said electrical machine using a switch that is in an open position in order to isolate the electrical machine from the on-board electrical power supply network when emergency reactivation is selected, and is using a control unit and a device for discharging storage elements to enable a series circuit comprising at least some of the N electrical energy storage elements to be connected in parallel with the on-board electrical power supply network, the voltage across the terminals of the electrical machine being configured by sequentially switching the number of the N storage elements so as to accompany the increase in the back-electromotive force from the electrical machine progressively as the speed of the gas generator associated with the turbine engine increases in such a manner that, while the rapid reactivation system is in operation, the electrical machine is powered by a voltage level above the level of its nominal characteristics.

9. The rapid reactivation method according to claim 8, wherein it further includes a step of controlling the charging of the storage elements by a charging and balancing device from the on-board electrical power supply network, outside periods of rapid reactivation.

10. The rapid reactivation method according to claim 8, wherein it further comprises a step of controlling the charging of the storage elements by means of a charging and balancing device and the switch from the electrical machine operating as an electricity generator, outside periods of rapid reactivation.
